(19) United States
(12) Patent Application Publication
(10) Pub. No.: US 2015/0220937 A1
(43) Pub. Date: Aug. 6, 2015

(54) SYSTEMS AND METHODS FOR APPENDING PAYMENT NETWORK DATA TO NON-PAYMENT NETWORK TRANSACTION BASED DATASETS THROUGH INFERRED MATCH MODELING

(71) Applicant: MasterCard International Incorporated, Purchase, NY (US)

(72) Inventors: Marianne Iannace, North Salem, NY (US); Luckner B. Polycarpe, Brooklyn, NY (US)

(73) Assignee: MasterCard International Incorporated, Purchase, NY (US)

(21) Appl. No.: 14/169,749

(22) Filed: Jan. 31, 2014

(51) Int. Cl. G06Q 30/02

(52) U.S. Cl. CPC G06Q 30/0201

(57) ABSTRACT

A method includes receiving a first data set and a second data set. The first data set may include anonymized transaction data that represents purchase transactions made by customers of a merchant. The second data set may include anonymized transaction data that represents purchase transactions made by cardholders in a payment network. The method further includes filtering the second data set to remove therefrom data relating to cardholders who are not customers of the merchant, and processing the first data set and the filtered second data set using a probabilistic engine to establish linkages between data in the first data set and data in the filtered second data set. The method may also include analyzing data in the filtered second data set to generate one or more of shopping habits data, classification data and attribute data with respect to customers of the merchant.

### BACKGROUND

Retail merchants are generally interested in learning more about their customers in order to enhance the effectiveness of the merchants' promotional and advertising efforts. Payment processors, networks and other entities create and process large quantities of potentially relevant data. At the same time, it is important that analysis of such data be performed in a manner that respects the privacy of individual customers.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 illustrates a system architecture within which some embodiments may be implemented.

FIG. 2 is a flow diagram depicting a process pursuant to some embodiments.

FIG. 3 is a flow diagram depicting a process pursuant to some embodiments.

FIGS. 4A and 4B are block diagrams depicting data tables pursuant to some embodiments.

FIG. 5 is a block diagram depicting a matching table pursuant to some embodiments.

FIG. 6 is a block diagram depicting a portion of an example output analysis pursuant to some embodiments.

FIG. 7 is a block diagram that illustrates a conventional payment card system.

FIG. 8 is another view of a system architecture within which some embodiments may be implemented.

FIG. 9 is a block diagram representation of a computer system provided in accordance with some aspects of the invention to implement some of the functionality illustrated in FIGS. 1 and 8.

FIG. 10 is a flow chart that illustrates a process that may be performed in the computer system of FIG. 9 in accordance with aspects of the present invention.

FIG. 11 is a block diagram of a data analysis toolkit that may be implemented in the computer system of FIG. 9 in accordance with aspects of the present invention.

### DETAILED DESCRIPTION

In general, and for the purpose of introducing concepts of embodiments of the present invention, a merchant may request data analytic services from a data services division of a payment network operator. The merchant may indicate what types of additional data it wishes to receive concerning the merchant's customers. The merchant may provide a set of de-identified transaction data for its customers to the payment network operator's data services division. The data services division may obtain de-identified transaction data generated within the payment network. The data services division may filter the network transaction data to remove therefrom data that does not relate to customers of the merchant. The data services division may probabilistically analyze the merchant data and the filtered network data in a manner that allows for linkage of network data to merchant data while assuring that the data subject to analysis remains de-identified. The data services division then may further analyze the linked data in a manner requested by the merchant to provide valuable insights about the merchant's customers based on the network data that has been linked to the merchant data. The results of the latter analysis may be appended to the merchant data as customer-level information and the customer-level information may be transmitted to the merchant.

The customer-level information received by the merchant may support enhanced marketing approaches by the merchant.

Embodiments of the present invention relate to systems and methods for analyzing transaction data. More particularly, embodiments relate to systems and methods for analyzing transaction data using data from a first transaction data provider (e.g., such as a payment card network) and data from a second transaction data provider (e.g., such as a merchant or group of merchants) in a way which ensures that personally identifiable information (“PII”) is not revealed or accessible during or after the analysis.

A number of terms are used herein. For example, the term “de-identified data” or “de-identified data sets” are used to refer to data or data sets which have been processed or filtered to remove any PII. The de-identification may be performed in any of a number of ways, although in some embodiments, the de-identified data may be generated using a filtering process which removes PII and associates a de-identified unique identifier (or de-identified unique “ID”) with each record (as will be described further below).

The term “payment card network” or “payment network” is used to refer to a payment network or payment system such as the systems operated by MasterCard International Incorporated (which is the assignee hereof), or other networks which process payment transactions on behalf of a number of merchants, issuers and cardholders. The terms “payment card network data” or “network transaction data” are used to refer to transaction data associated with payment transactions that have been processed over a payment network. For example, network transaction data may include a number of data records associated with individual payment transactions that have been processed over a payment card network. In some embodiments, network transaction data may include information identifying a payment device or account, transaction date and time, transaction amount, and information identifying a merchant or merchant category. Additional transaction details may be available in some embodiments.

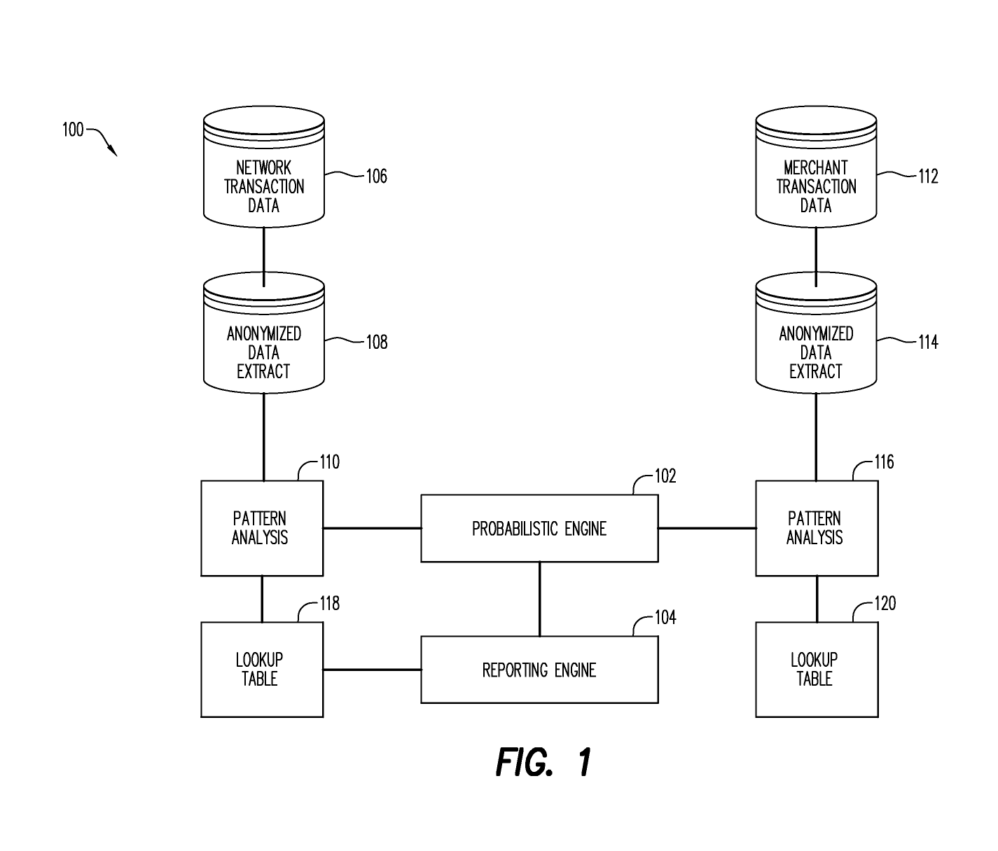

Features of some embodiments of the present invention will now be described by first referring to FIG. 1 where a block diagram of portions of a transaction analysis system 100 are shown. The transaction analysis system 100 may be operated by or on behalf of an entity providing transaction analysis services. For example, in some embodiments, system 100 may be operated by or on behalf of a payment network or association (e.g., such as MasterCard International Incorporated) as a service for entities such as member banks, merchants, or the like.

System 100 includes a probabilistic engine 102 in communication with a reporting engine 104 to generate reports, analyses, and data extracts associated with data matched by the probabilistic engine 102. In some embodiments, the probabilistic engine 102 receives or analyzes data from several data sources, including network transaction data 106 (e.g., from payment transactions made or processed over a payment card network) and merchant transaction data 112 (e.g., from purchase transactions conducted at one or more merchants). The data from each data source 106, 112 is pre-processed before it is analyzed using the probabilistic engine 102. In some embodiments, the data is used to first create an anonymized data extract 108, 114 in which any PII is removed from the data. Pursuant to some embodiments, the anonymized data extract 108, 114 is created by generating a de-identified unique identifier code that is derived from a unique transaction identifier of each transaction in the source data 106, 112. For example, with respect to the network transaction data 106, a function may be applied to a transaction identifier associated with each transaction and transaction record to create a de-identified unique identifier associated with each transaction. In some embodiments, the function may be a hash function or other function so long as the unique identifier cannot by itself be linked to the individual transaction record (for example, an entity that has access to the anonymized data extract 108 is not able to identify any PII associated with a de-identified unique identifier in the extract 108).

The merchant transaction data 112 may be provided to an entity operating the system of the present invention via a secure file transfer (e.g., via sFTP or the like) and associated with a unique merchant identifier. The merchant transaction data 112 may include sales ledger data in a pre-defined format that contains information associated with a plurality of transactions conducted at the merchant including, for example, transaction date/time/spend, store location and a unique identifier associated with the transaction (such as, for example, a customer unique identifier). In some embodiments, the customer unique identifier (“UID”) is selected such that it is not personally identifiable. The customer UID, in some embodiments, is delivered using a de-identified unique identifier generated from the transaction data received from the merchant point of sale systems for continuity between transactions, and is selected to be persistent across transactions. For example, the customer UID may show up numerous times throughout a file provided by a merchant (e.g., the UID may be associated with transactions performed at different store locations, at different times, and with different transaction amounts). In some embodiments, the merchant data extract is tender agnostic, and includes transactions conducted with cash, payment cards, or the like. In general, the number of merchant transactions in the merchant data extract should be higher than the number of payment network transactions extracted by data extract 108 for the merchant as the merchant data extract includes transactions conducted with different tenders including payment network transactions.

Pursuant to some embodiments, the type of data extracted by modules 108, 114 depends on the type of information to be analyzed by the system 100. For example, the data extract 108 may be an extract of the same type of information to be provided by a merchant in data extract 114 (e.g., such as transaction date and time, transaction amount, store location and frequency data). In some embodiments, the data extract may be a sample of a larger set of data, or it may be an entire data set. Further, when extracting payment network data (at 108), information associated with the merchant for which an analysis is to be performed may be used to limit the extract. For example, if an analysis is to be performed for a specific merchant, the extract 108 may be limited to transactions performed at that specific merchant (including all locations or all locations in a specific geographical region). As a specific illustrative example, extract 108 may include a number of records of data, each including a de-identified unique ID, a transaction date, a transaction time, a transaction amount or spend, a store location identifier (identifying a specific store or merchant location), and an aggregate merchant identifier (identifying a specific merchant chain or top level identifier associated with a merchant). Those skilled in the art, upon reading this disclosure, will appreciate that other data fields may also be included depending on the nature of the analysis to be performed.

With respect to the data extract 114 of merchant transaction data 112, in some embodiments, the extract retrieves data elements including a customer UID, a transaction date, a transaction time, a transaction spend, and a store location ID (although those skilled in the art will appreciate that additional or other fields may be extracted depending on the nature of the analysis to be performed).

In some embodiments, the function or process of generating an anonymized data extract 108, 114 may be performed by an entity providing the data. For example, the anonymized data extract 108 may be generated by, or on behalf of, the payment association or the payment network and provided as an input or batch file to an entity operating system 100. As another example, the anonymized data extract 114 may be generated by, or on behalf of, a merchant (or group of merchants) wishing to receive reports or analyses from the system 100.

The system 100 also includes pattern analysis modules 110, 116. Pattern analysis modules 110, 116 may include data, rules or other criteria which define different patterns identified for analysis. Each pattern may be identified by a unique pattern identifier which may be, for example, a random number. Each pattern may be a unique pattern of date/time/spend, store location, and transaction frequency (or other combinations of data for which pattern analysis is desired). The pattern analysis modules 110, 116 may be code or applications which are designed for pattern analysis or may be part of an analysis system or module.

In use, pattern analysis module 110 generates a file, table or other extract of data that is used as an input to the probabilistic engine 102 and which is based on the anonymized and extracted network transaction data. The pattern analysis module 110 may be operated to generate a file, table or other extract of data that includes a number of transactions filtered by an aggregate merchant identifier (e.g., a group of transactions associated with a particular merchant or retail chain across different stores or locations). The module 110 may also summarize and profile the data by each unique combination of transaction date/time/spend, location, and frequency. A new profile identifier may be assigned for each pattern, and the data provided for input to the probabilistic engine 102 may have the de-identified unique ID removed before provision to the engine 102. In some embodiments, the removed unique ID and the assigned profile identifier may be stored in a separate lookup table 118 for later use by the reporting engine 104.

The pattern analysis module 116 generates a file, table or other extract of merchant transaction data that is used as an input to the probabilistic engine 102 and which is based on the anonymized and extracted merchant transaction data provided by module 114. The pattern analysis module 116 may be operated to generate a file, table or other extract of data which has been cleansed to ensure standard formatting of the merchant data for use by the probabilistic engine 102. The cleansing may include the removal of any unnecessary data provided by the merchant. For example, in one specific embodiment, the merchant data may be cleansed to remove all fields other than a customer UID, a transaction date, a transaction time, a transaction spend, and a location ID. The pattern analysis module 116 may further operate to summarize the data by UID to ascertain a frequency of transactions in the merchant data file, and to further summarize and profile data by each combination of transaction date/time/spend, location, and frequency. Upon generation of the extract, a new merchant profile identifier may be assigned to the extract. The merchant profile identifier and the UID are removed from the file output from the pattern analysis module 116. A separate lookup table 120 may be created to store the dropped UID and the merchant profile identifier for later use by the reporting engine 104.

Pursuant to some embodiments, the probabilistic engine 102 operates to perform an inferred match analysis to assess the inferred linkage for uniqueness and direct linkage. This allows further assurance of anonymity and avoids use of any PII. Pursuant to some embodiments, a uniqueness probability is derived from the relationship between the number of unique IDs for the Network Profile and the unique Merchant Profiles. As the probability of a direct link, (driven by uniqueness), approaches 100%, the risk of divulging or revealing some PII increases. For data analysis to identify product or marketing effectiveness, a pattern match of 100% is ideal. However, as the uniqueness of the match approaches 0%, the product or marketing effectiveness decreases significantly. By using features of the present invention to identify the uniqueness probability using anonymized transaction data, embodiments allow marketers, product developers, and analysts to identify trends or actual patterns and to adjust marketing, product development and other features accordingly.

In general, as used herein, the term “direct linkage” refers to the relationship between the probability match and the uniqueness probability. 100% “direct linkage” occurs when the probability match is 100% and the uniqueness probability is 100%. To avoid potentially revealing PII, in some embodiments, it may be desirable to reject any matches where there is 100% direct linkage. Pursuant to some embodiments, the primary inferred match is those records having the highest probabilities within a predetermined acceptance range.

Pursuant to some embodiments, the output of the processing performed by system 100 may be an analysis or report which is generated by the reporting engine 104. To facilitate the reporting and to ensure that PII is not divulged, the reporting engine may use the lookup tables 118, 120 to assign each de-identified merchant profile (from table 120) to one network profile (from table 118). This ensures that the de-identified customers remain de-identified.

As used herein, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. In addition, entire modules, or portions thereof, may also be implemented in programmable hardware devices such as field programmable gate arrays, programmable array logic, programmable logic devices or the like or as hardwired integrated circuits.

In some embodiments, the modules of FIG. 1 are software modules operating on one or more computers. In some embodiments, control of the input, execution and outputs of some or all of the modules may be via a user interface module (not shown) which includes a thin or thick client application in addition to, or instead of a web browser.

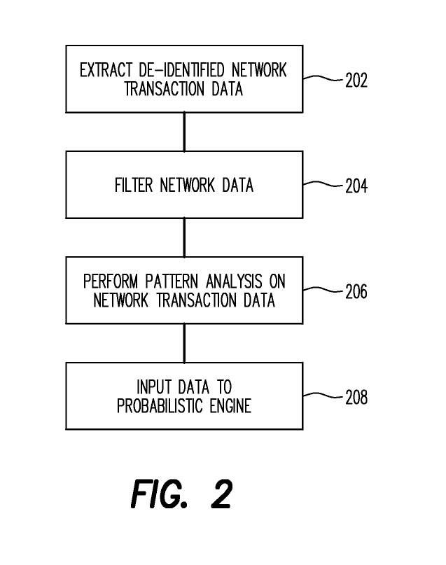

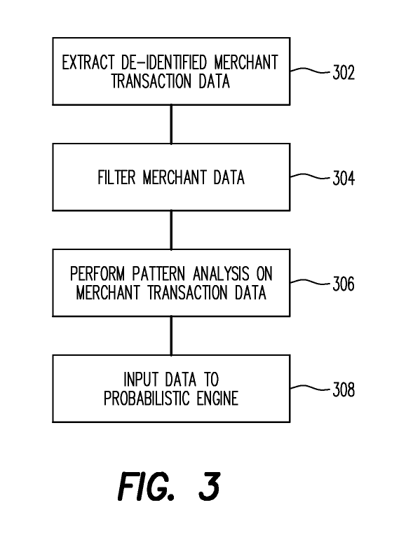

Reference is now made to FIGS. 2-3 which are flow diagrams depicting processes 200, 300 for operating the system 100 of FIG. 1 pursuant to some embodiments. Some or all of the steps of the processes 200, 300 may be performed under control of the system 100 and may include users or administrators interacting with the system via one or more user devices (not shown).

In the process 200, network transaction data is extracted from a transaction datastore 106 and a pattern analysis is performed to produce a file for input to probabilistic engine 102. The process 200 begins at 202 where a payment network data extract is performed to provide de-identified data from the payment network associated with a particular merchant or group of merchants. The de-identified data extract may include an extract of fields for payment network transactions, including: a de-identified unique ID (generated as described above), an aggregate merchant ID, a transaction date, a transaction time, a transaction spend, and a location ID. In the case where the payment network is the network operated by MasterCard International Incorporated, the data extract will include a number of transactions conducted using MasterCard-branded payment cards.

Processing continues at 204 where the de-identified data extracted at 202 is filtered, producing a filtered output file having a number of transactions for a particular merchant or group of merchants, resulting in a file of payment network transactions conducted at those merchants and each including: a de-identified unique ID, a transaction date, a transaction time, a transaction spend, and a location ID.

Processing continues at 206 where a pattern analysis is performed to identify a frequency of transactions. The pattern analysis may result in the creation of a file including, for each transaction, a de-identified unique ID, a transaction date, a transaction time, a transaction spend, a location ID, and a frequency variable.

Processing continues at 208 where data is provided to the probabilistic engine 102 including a number of transactions each including a number of fields such as: transaction date, transaction time, transaction spend, a location ID, a frequency variable, and a profile ID. The profile ID is associated with an entry in a lookup table created to store the profile ID in association with the de-identified unique ID for each transaction. In this way, data may be input to the probabilistic engine 102 without any identifier (e.g., the de-identified unique ID is removed from the data input to the probabilistic engine 102, and instead a lookup is provided external to the probabilistic engine 102).

Similar processing is performed on the merchant data. For example, as shown in FIG. 3, a process 300 is performed which starts at 302 with the extraction of de-identified merchant data, including a number of transactions (across different tenders) conducted at the merchant. The transaction data includes: a customer UID, a transaction date, a transaction time, a transaction spend, a location identifier, and, in some embodiments, a tender flag (which identifies the form of tender used in each transaction).

The data extract from 302 is then filtered and cleansed at 304 to produce a data file including, for each transaction in the extract, a customer UID, a transaction date, a transaction time, a transaction spend and a location ID.

Processing continues at 306 where the filtered data from 304 is processed using a pattern matching system to derive frequency data associated with the filtered and extracted merchant data. The pattern matching causes the creation of a file having, for each transaction, a customer UID, a transaction date, a transaction time, a transaction spend, a location ID and a frequency variable. A portion of this data is provided as the merchant input to the probabilistic engine 102 at 308, including, for each transaction, a transaction date, a transaction time, a transaction spend, a location ID, a frequency, and a merchant profile ID. The merchant profile ID is associated with a lookup table that is created to associate the customer UID with the pattern or data output at 306. In this way, merchant transaction data may be input to the probabilistic engine 102 without any customer identifier (e.g., the customer UID is removed from the data input to the probabilistic engine 102, and instead a lookup is provided external to the probabilistic engine 102).

By providing such anonymized data to the probabilistic engine 102, a number of analyses and reports may be generated without revealing any PII or other sensitive information. For example, the probabilistic engine 102 may be operated to establish a linkage between a merchant's sales ledger and the de-identified payment network transaction data. The linkage is a probability score between the merchant data and the payment network transaction data based upon spending patterns provided by the merchant along with spending patterns observed in the payment network transaction data. The linkage, on its own, does not necessarily provide any intrinsic value; however, the inferred match is a necessary component to build out merchant applications by providing a link (on a transaction level) between a merchant data file and a payment network data file. As a result, merchants may enjoy the use of a number of analytic and modeling applications including the ability to generate aggregate reports, probability scores and model algorithms. There will be described below examples of analysis tools that may be applied to the linked data to provide valuable insights to the merchant about their customer's activities and/or propensities with the respect to their transactions in the payment network.

The two inputs provided to the probabilistic engine 102 include profiles at the network profile level (from pattern analysis 110) and profiles at the merchant profile level (from pattern analysis 116). The profiles may range in quantity of unique accounts (e.g., unique records associated with an account, or the like) from x to 1, and unique transactions from >x to 1.

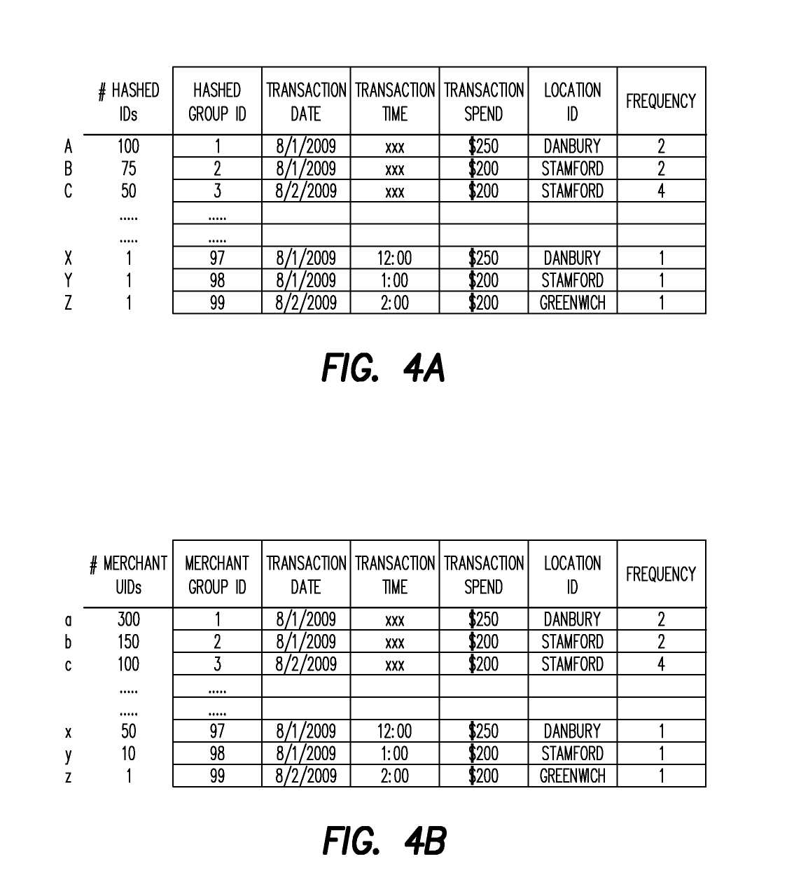

An illustrative example of a portion of data associated with a network profile is shown in FIG. 4A, and FIG. 4B illustrates a portion of data associated with an example table showing a profile at the merchant profile level pursuant to some embodiments.

Pursuant to some embodiments, the probabilistic engine 102 operates to match the merchant profile data with the network profile data with some level of probability. The level of probability, as used herein, is referred to as “the pattern match”. The pattern match could range from 0 to 1 (i.e., 0 to 100%). In addition to the pattern match, the probability of uniqueness could range from 0 to 1.

Network profiles and merchant profiles are linked in a many-to-many fashion and given some level of probability for each pattern match (e.g., 100 network profiles and 100 merchant profiles result in 10,000 probabilities). The match may not be exact—for example, the network profile may say that the spending associated with a specific transaction involved a credit card payment, while the merchant record may have a profile that indicates that the transaction was a cash transaction. These discrepancies may be matched and assigned a match probability. The linking is not actual—instead, a probability match is assigned ranging from 0 to 1 for each combination of records. An illustration of the many-to-many pattern match is shown in FIG. 5. In the illustrative example of FIG. 5, a match analysis is shown associated with an analysis performed using the system of FIG. 1 where the network transaction data is from a specific payment network—the network operated by MasterCard International Incorporated. In the illustrative match shown in FIG. 5, a “MasterCard Profile A” matches to a “Merchant Profile a” with a probability of 100%. Further, “Profile B” matches to “Profile b” with a probability of 100%, and so forth, because the patterns are identical. Other combinations are not identical, and therefore have a match probability of less than 100%.

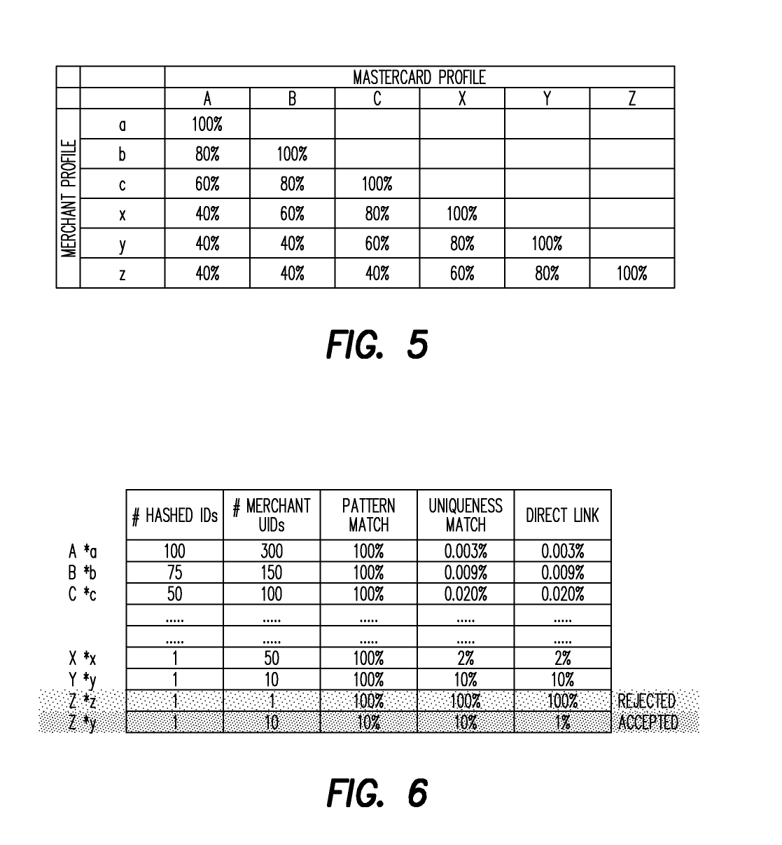

FIG. 6 illustrates an example output of the inferred match process pursuant to some embodiments. The probabilities and acceptance scores are purely for illustrative purposes and are not intended to be limiting. The output of the inferred match process may be produced or manipulated by the reporting engine 104 for use by other applications.

Pursuant to some embodiments, the operation of the system 100 may be based on several assumptions or rules to protect PII. Such assumptions or rules may include ensuring that the combined data set (including network data and merchant data) is not disclosed to the merchant, all applications are specific to a merchant and are not to be shared with other parties, algorithms or scores are created using matched data and no algorithm or score is created using single transaction matches.

Pursuant to some embodiments, the techniques described above may be used in conjunction with a number of different applications. For example, in one embodiment, an aggregated report is produced based on a merchant data file, with an inferred match modeling link to different merchant unique identifiers. In some embodiments, enhanced and aggregated reports may be produced, with inferred match links to merchant unique identifiers utilizing additional “SKU” data from the merchant (e.g., where the SKU level data is received in the merchant transaction data at 112). In some embodiments, data append services may be delivered at the de-identified merchant unique identifier level. Data may be produced as an aggregated metric/probability score. Further, pursuant to some embodiments, an algorithm may be provided designed to score a list outside of a payment network (e.g. for or about a merchant or other third party).

Thus, embodiments of the present invention allow merchants, networks, and others to accurately generate and investigate transaction profiles, without need for added controls to protect and secure PII. Although a number of “assumptions” are provided herein, the assumptions are provided as illustrative but not limiting examples of one particular embodiment—those skilled in the art will appreciate that other embodiments may have different rules or assumptions.

Pursuant to some embodiments, systems, methods, means, computer program code and computerized processes are provided to generate inferred match or linkage between de-identified data in different transaction data sets. In some embodiments, the systems, methods, means, computer program code and computerized processes include receiving a first set of de-identified transaction data from a first transaction data source, receiving a second set of de-identified transaction data from a second transaction data source, filtering the first and second sets of de-identified transaction data to identify transactions associated with at least a first entity and to create first and second filtered data sets, removing data associated with an identifier field for each of the transactions in the first filtered data set to create a de-identified first data set, removing data associated with an identifier field for each of the transactions in the second filtered data set to create a de-identified second data set, and processing the first and second de-identified data sets using a probabilistic engine to establish a linkage between data in each data set.

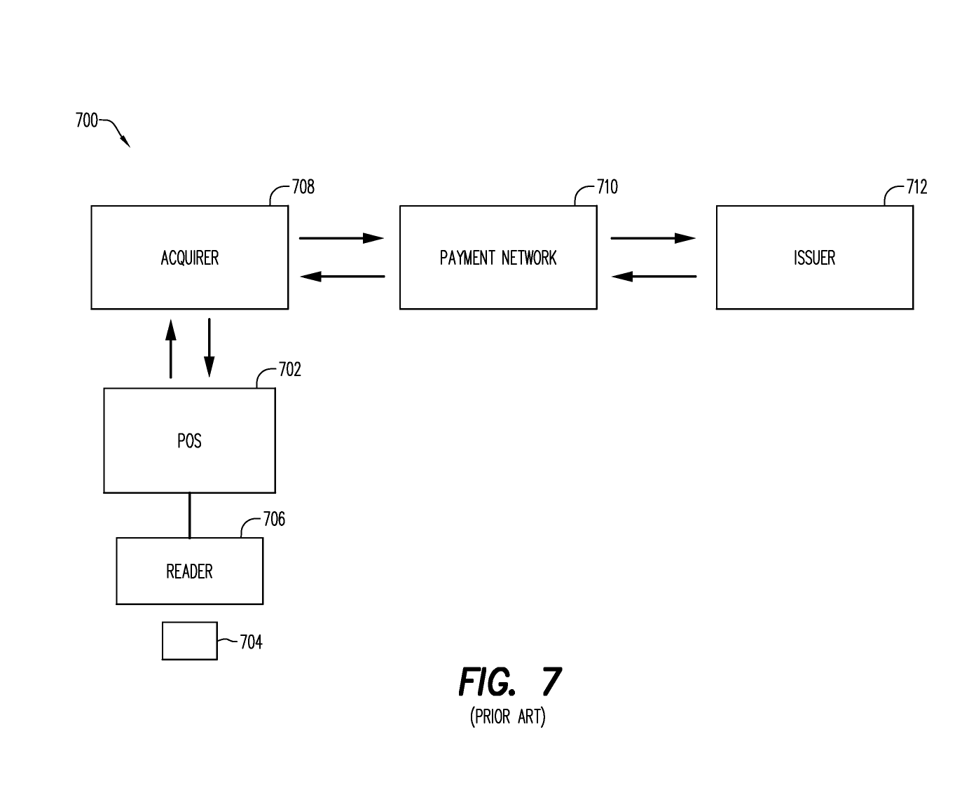

For further background, a conventional card-based payment system (such as that operated by MasterCard International Incorporated) will now be described. FIG. 7 is a block diagram representation of such a system, which is generally indicated in the drawing by reference numeral 700. In particular, the representation of the payment system 700 in FIG. 7 reflects the flow of information and messaging for a single payment card transaction.

Thus the transaction in question may originate at a POS (point of sale) device 702 located in a merchant store (which is not separately indicated). A payment card 704 is shown being presented to a reader component 706 associated with the POS device 702. The payment card 704 is often implemented as a magnetic stripe card, although alternatively, or in addition, the payment card 704 may include capability for being read by proximity RF (radio frequency) communication with an integrated circuit (IC) chip (not separately shown). The primary account number (PAN) for the payment card account represented by the payment card 704 may be stored on the magnetic stripe (not separately shown) and/or the IC chip (if present) for reading by the reader component 706 of the POS device 702.

In some installations, the reader component 706 may be configured to perform either or both of magnetic stripe reading and reading of IC chips by proximity RF communications. Thus, the payment card 704 may be swiped through a mag stripe reading portion (not separately shown) of the reader component 706, or may be tapped on a suitable surface of the reader component 706 to allow for proximity reading of its IC chip.

In some transactions, instead of a card-shaped payment device, such as the payment card 704, a suitable conventional payment-enabled mobile phone or a payment fob may be presented to and read by the reader component 706.

According to practices employed by some merchants, the POS device 702 may in some embodiments be implemented as a suitably programmed smart phone or tablet computer having a small mag stripe reading accessory attached thereto.

A computer 708 operated by an acquirer (acquiring financial institution) is also shown as part of the system 700 in FIG. 7. The acquirer computer 708 may operate to receive an authorization request for the transaction from the POS device 702. The acquirer computer 708 may route the authorization request via a payment network 710 to the server computer 712 operated by the issuer of the payment card account that is available for access by the payment card 704. The authorization response generated by the payment card issuer server computer 712 may be routed back to the POS device 702 via the payment network 710 and the acquirer computer 708.

The payment network 710 may be for example the well-known Banknet system operated by MasterCard International Incorporated, which is the assignee hereof.

The diagram shown in FIG. 7 schematically represents an in-store payment card purchase transaction. However, as is well known, payment card accounts may also be used for online (e-commerce) purchase transactions. In such a transaction, the merchant's e-commerce server computer (not shown) may take the place of the indicated POS device and may be in communication with the acquirer.

The components of the system 700 as depicted in FIG. 7 are only those that are needed for processing a single transaction. A typical payment system 700 now in use may include a considerable number of payment card issuers and their computers, a considerable number of acquirers and their computers, and numerous merchants and their POS devices and associated reader components. The system may also include a very large number of payment card account holders, who carry payment cards and/or other payment-enabled devices.

In the course of receiving and relaying the authorization requests and responses, the payment network 710 may receive and store large quantities of transaction data, including for each one of many transactions, the PAN, the date and time of the transaction, the transaction total amount, the merchant, and the store location. This transaction data, referred to above and below as payment network transaction data, may serve as the raw material for the network profiles referred to in the above description of an inferred match process.

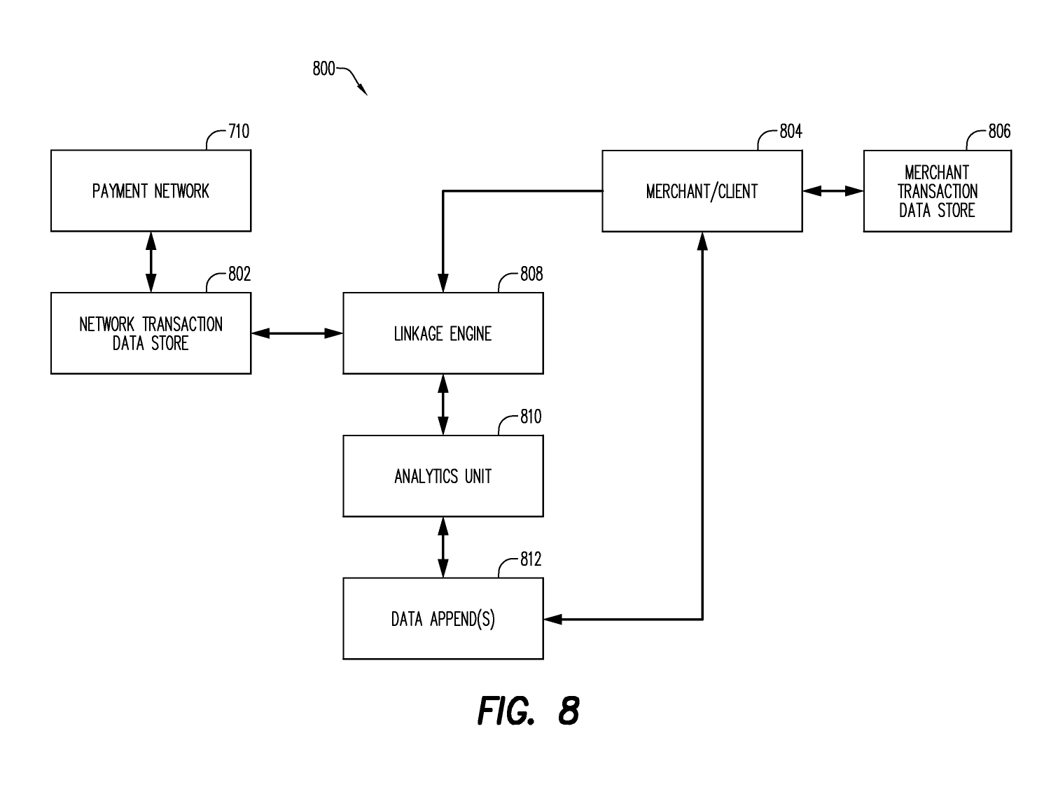

FIG. 8 is another view of a system architecture within which some embodiments may be implemented. The system as a whole as depicted in FIG. 8 is generally indicated by reference numeral 800. The data analysis system 800 shown in FIG. 8 can be considered as in some ways an alternative embodiment of the transaction analysis system 100 of FIG. 1. One component of the data analysis system 800 may be the same payment network 710 referred to above in connection with FIG. 7. Associated with the payment network 710 is a data store 802 which stores at least some of the transaction data generated and/or received by the payment network 710 in processing payment transactions. The network transaction data store 802 may have processing capability which is not separately shown, and may process the network transaction data stored therein to produce a data set of de-identified network transaction data (also referred to as “anonymized” network transaction data) that is suitable for use in an inferred match process as described above.

Also shown in FIG. 8 is a merchant block 804. The merchant block 804 may include computing capabilities and may represent a merchant that wishes to request data analysis and enhancement services from a client services division of the operator of the payment network 710. With respect to those services, the merchant may function as a business client of the payment network 710 and/or its client services division. There is associated with the merchant block 804 a data store 806 in which the merchant stores its customer transaction data. Either or both of the merchant block 804 and the merchant transaction data store 806 may have capabilities for producing a de-identified (also referred to as “anonymized”) data set of merchant transaction data that is suitable to serve as an input to the inferred match process.

Also shown in FIG. 8 is a linkage engine 808, which may embody inferred match processing as described above in connection with FIGS. 1-6. The linkage engine 808 is in data communication with the network transaction data store 802 and with the merchant block 804 to respectively receive therefrom the anonymized network transaction data set and the anonymized merchant transaction data set. The linkage engine 808 is also functionally connected with an analytics unit 810. The analytics unit 810 may process the network transaction data as linked by the linkage engine 808 to the anonymized merchant transaction data. The processing by the analytics unit may produce one or more types of additional data related to the merchant's customers based on network transaction data linked by inference and on a de-identified basis to those customers.

FIG. 8 also shows a data append unit 812. The data append unit 812 is also functionally connected to the analytics unit 810. The data append unit 812 may receive the additional customer-level information produced by the analytics unit 810 and may append that information to the merchant transaction data set received from the merchant block 804. The resulting customer-level information obtained from the anonymized network transaction data, may be sent to the merchant block 804 from the data append unit 812. The merchant/client may find the customer-level information to be of enhanced usefulness in the merchant's marketing and advertising efforts.

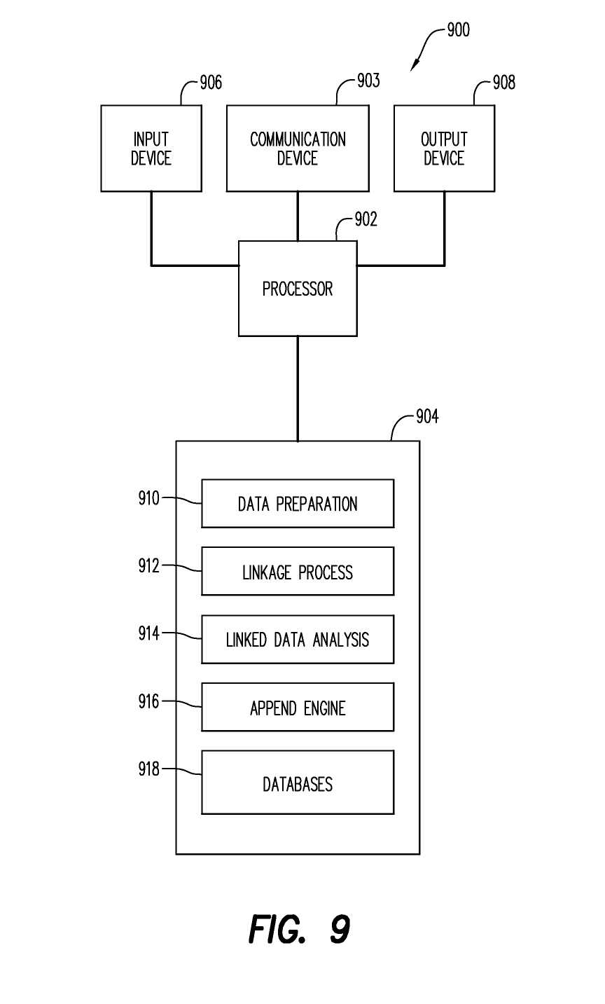

Further details of the operations of the data analysis system 800 will be described below with reference to FIGS. 9-11.

FIG. 9 is a block diagram representation of a computer system 900 provided in accordance with some aspects of the invention. The computer system 900, which will be referred to as a “transaction analysis computer”, may incorporate the functionality of the linkage engine 808, the analytics unit 810 and the data append unit 812.

The transaction analysis computer 900 may be conventional in its hardware aspects but may be controlled by software to cause it to function as described herein. The transaction analysis computer 900 may include a computer processor 902 operatively coupled to a communication device 903, a storage device 904, an input device 906 and an output device 908.

The computer processor 902 may be constituted by one or more conventional processors. Processor 902 operates to execute processor-executable steps, contained in program instructions described below, so as to control the transaction analysis computer 900 to provide desired functionality.

Communication device 903 may be used to facilitate communication with, for example, other devices (such as the merchant block 804 and the network transaction data store 802 shown in FIG. 8). For example (and continuing to refer to FIG. 9), communication device 903 may comprise a number of communication ports (not separately shown), to allow the transaction analysis computer 900 to communicate simultaneously with a number of other computers and other devices.

Input device 906 may comprise one or more of any type of peripheral device typically used to input data into a computer. For example, the input device 906 may include a keyboard and a mouse. Output device 908 may comprise, for example, a display and/or a printer.

Storage device 904 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 904 stores one or more programs for controlling processor 902. The programs comprise program instructions (which may be referred to as computer readable program code means) that contain processor-executable process steps of the transaction analysis computer 900, executed by the processor 902 to cause the transaction analysis computer 900 to function as described herein.

The programs may include one or more conventional operating systems (not shown) that control the processor 902 so as to manage and coordinate activities and sharing of resources in the transaction analysis computer 900, and to serve as a host for application programs (described below) that run on the transaction analysis computer 900.

The programs stored in the storage device 904 may also include a data preparation application program 910 that controls the processor 902 to enable transaction analysis computer 900 to pre-process one or both of the data sets received from the network transaction data store 802 and the merchant block 804. For example, the data preparation application program 910 may filter the payment network transaction data by removing data for all cardholders who have not engaged in at least one transaction with the merchant/client represented by block 804. In addition or alternatively, the data preparation application program 910 may if necessary cleanse the merchant transaction data set so that it is in a suitable format for the inferred match process and does not contain any extraneous data.

Another program that may be stored in the storage device 904 is data linkage process application program 912. The data linkage process application program may control the processor 902 to enable the transaction analysis computer 900 to perform the inferred match process described above with reference to FIGS. 1-6.

The storage device 904 may also store a linked data analysis application program 914. The linked data analysis application program 914 may process that network transaction data that has been linked to merchant transaction data so as to develop information about the merchant's customers that may be of interest to the merchant. Below, and particularly in connection with FIG. 11, there will be descriptions of examples of types of valuable customer-level information that may be produced by the linked data analysis application program 914.

The storage device 904 may further store an append engine program 916. The append engine program 916 may append to the merchant transaction data set some or all of the customer-level information produced by the linked data analysis application program 914.

The storage device 904 may also store, and the transaction analysis computer 900 may also execute, other programs, which are not shown. For example, such programs may include a reporting application, which may respond to requests from system administrators for reports on the activities performed by the transaction analysis computer 900. The other programs may also include, e.g., data communication software, database management software, device drivers, etc.

The storage device 904 may also store one or more databases 918 required for operation of the transaction analysis computer 900. Such databases may store, for example, at least on a temporary basis, the anonymized network transaction data set and the anonymized merchant transaction data set, and/or one or more subsets thereof, as needed for the processing by application programs 910, 912, 914 and 916.

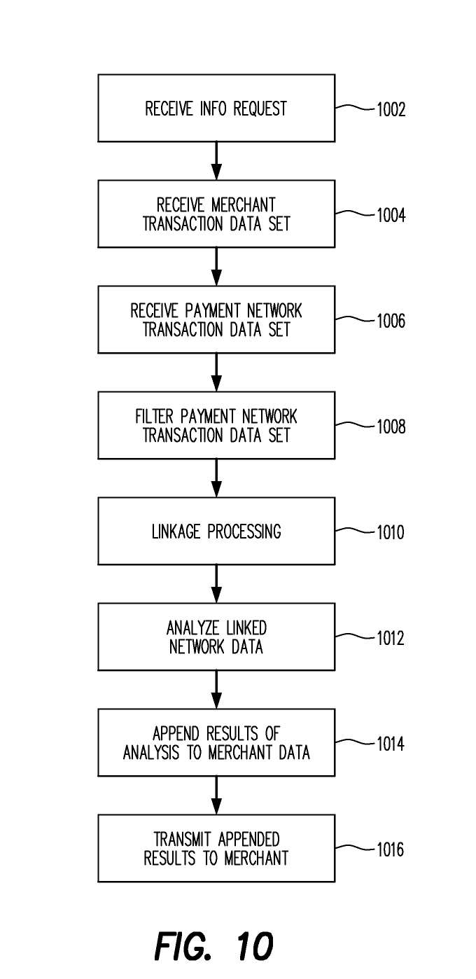

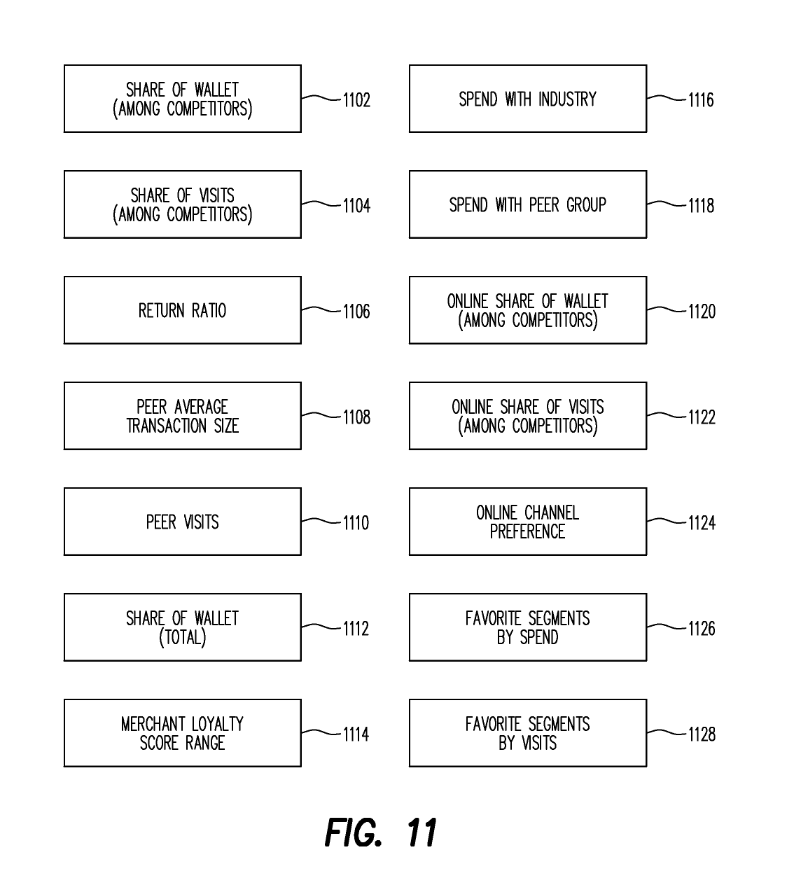

FIG. 10 is a flow chart that illustrates a process that may be performed in the transaction analysis computer 900 of FIG. 9 in accordance with aspects of the present invention.

At 1002 in FIG. 10, the transaction analysis computer 900 receives from the merchant/client (block 804, FIG. 8) a request that the data services division/payment network provide information, derived from network transaction data stored by the payment network 710, concerning the merchant's customers. In some embodiments, this request may be received by data communication from the merchant block 804 to the transaction analysis computer 900. In addition or alternatively, the request, or a portion of the request, may be made by another type of communication, including oral communication. The requested information may then be indicated to the transaction analysis computer 900 by an operator of a peripheral input device that is part of or in communication with the transaction analysis computer 900. Examples of the types of information that the merchant may request are described below in connection with FIG. 11.

At 1004 in FIG. 10, the transaction analysis computer 900 receives the above-mentioned anonymized merchant transaction data set from the merchant block 804.

At 1006, the transaction analysis computer 900 receives the above-mentioned anonymized payment network transaction data set from the network transaction data store 802.

At 1008, the transaction analysis computer 900 filters the anonymized payment network transaction data, by, for example, removing from that data set all data relating to cardholders who are not customers of the merchant/client. In addition, the transaction analysis computer 900 also may perform data conditioning/cleansing on the anonymized merchant transaction data set. Further data conditioning may also be performed on the anonymized payment network transaction data set.

At 1010, the transaction analysis computer 900 applies an inferred match process, as described above with reference to FIGS. 1-6, to establish linkages between the merchant transaction data set and the filtered payment transaction data set. As noted above, this may involve operation of a probabilistic engine (block 102, FIG. 1) to determine the likelihood of matches between profiles of merchant customer data and profiles of payment network transaction data.

Continuing to refer to FIG. 10, at 1012 the transaction analysis computer 900 may analyze data from the anonymized payment network transaction data that has been linked to the merchant transaction data to generate information concerning customers of the merchant. As will be seen, particularly from the discussion below of FIG. 11, the customer-level information generated at 1012 may include one or more of data concerning customers' shopping habits, data concerning classifications of customers into groups and data concerning one or more attributes of customers.

At 1014, the transaction analysis computer 900 may associate the customer-level information generated at 1012 with relevant anonymized customer identifiers (i.e., customer UIDs as referred to above in connection with block 302 in FIG. 3) that were part of the merchant transaction data set received at 1004. This has the effect of appending the customer-level information generated at 1012 to the merchant transaction data set. Then, at 1016 in FIG. 10, the transaction analysis computer 900 may send the anonymized customer identifiers with the associated customer information back to the merchant block 804 (FIG. 8).

FIG. 11 is a block diagram of a data analysis toolkit that may be implemented in the transaction analysis computer 900 in accordance with aspects of the present invention. The various data analysis tools illustrated in FIG. 11 may all be components of the linked data analysis application program shown in FIG. 9. One or more of the data analysis tools illustrated in FIG. 11 and described below may be employed as part of the processing referred to above in connection with block 1012 of FIG. 10. In some embodiments, the particular data analysis tool(s) selected for use at block 1012 may be determined based on the type or types of information indicated in the merchant/client's request received at block 1002.

Block 1102 in FIG. 11 represents a data analysis tool that may be referred to as a “share of wallet” (SOW) analysis tool. The output from this tool may represent the proportion of the spending done by the customer in question with the merchant/client during a pre-defined time period relative to the customer's total spending in a pre-defined group of merchants during that time period, where the group of merchants may consist of the merchant/client and a set of its competitors. This output, for each customer, may be expressed as a percentage obtained by adding up the customer's transaction amounts with the merchant/client during the time period and dividing the resulting sum by the total amount of the customer's transactions with the group of merchants during that time period. One of the inputs to the SOW analysis tool is data to indicate the identities of the merchants considered to be the competitors of the merchant/client for the purpose of the operation of the SOW tool.

Block 1104 represents a data analysis tool that may be referred to as a “share of visits” (SOV) analysis tool. The output from this tool may represent the proportion of “visits” (i.e. transactions) by the customer in question with the merchant/client during a pre-defined time period relative to the total number of transactions by the customer in a pre-defined group of merchants during the time period, where the group of merchants may consist of the merchant/client and a set of its competitors. This output, for each customer, may be expressed as a percentage obtained by adding up the number of the customer's transactions with the merchant/client during the time period and dividing the resulting sum or total by the customer's total number of transactions with the group of merchants during that time period. At least some variations in this tool are possible. For example, when two or more transactions occur relatively close in time (say within an hour or two) at the same retail location, all but one of the transactions may be disregarded in totaling up the customer's store visits. This variation may reflect the fact that a customer may engage in more than one payment network transaction (particularly at a department store) during a single physical visit to the store. The SOV output may thus be calculated on either or both of the basis of physical visits and/or total payment network transactions (with the merchant/client and with the group of merchants). Moreover, online transactions either may or may not be considered as “visits” for the purpose of this analysis tool, and/or the output from the tool may be calculated both ways. Among the various embodiments of this analysis tool, any one or more permutations of combinations of the above mentioned variations may be included or not included in calculating one or more outputs from the analysis tool.

Block 1106 represents a data analysis tool that may be referred to as a “return ratio” tool. The output of this tool may indicate a proportion of return transactions engaged in by the customer in question relative to the customer's total purchase transactions. This output, for each customer, may be expressed as a percentage obtained by adding up the total number of the customer's product return transactions in the payment network during the time period and dividing the resulting sum or total by the customer's total number of transactions in the payment network during that time period. Again, there are possible variations in the way this calculation may be performed. For example, the latter total number of transactions may be added up while excluding product return transactions. In addition or alternatively, one or more outputs from the analysis tool may indicate when the return transaction is partial (i.e., not all purchased items returned from the original transaction). According to further possible variations, the return ratio output may be calculated for a particular group of merchants, such as a group of competitors relative to the merchant/client, with the group either including or not including the merchant client. Among the various embodiments of this analysis tool, any one or more permutations of combinations of the above mentioned variations may be included or not included in calculating one or more outputs from the analysis tool.

Block 1108 represents a data analysis tool that may be referred to as a “peer average transaction size” tool. The output of this tool may indicate the average dollar amount of transactions engaged in by the customer in question for a group of merchants, such as a group of merchants that includes the merchant/client, and/or a group of merchants considered to be peers of the merchant/client. Again, variations and/or multiple outputs from this tool are possible, such as including or not including transactions with the merchant/client in the calculation of the output(s).

Block 1110 represents a data analysis tool that may be referred to as a “peer visits per account” tool. The output of this tool may indicate the average frequency of transactions engaged in by the customers in a group of merchants. As before, the group of merchants may be a pre-defined set of competitors of the merchant/client. According to variations, like those described above, the group of merchants may or may not include the merchant/client for purposes of the calculation. According to other variations, second and subsequent transactions that likely are attributable to the same physical visit may be disregarded in calculating the outputs of the tool. Online transactions may or may not be disregarded. Among the various embodiments of this analysis tool, any one or more permutations of the above mentioned variations may be included or not included in calculating one or more outputs from the analysis tool. It will be understood that the calculation may deal only with transactions occurring during a pre-determined period of time.

Block 1112 represents a data analysis tool that may be referred to as a “SOW total” (share of wallet total) tool. The output of this tool may include, for the customer in question, the proportion of the customer's spending with the merchant relative to the customer's total spending in the payment network, in each case during a pre-determined period of time. This output, for each customer, may be expressed as a percentage obtained by adding up the customer's transaction amounts with the merchant/client during the time period and dividing the resulting sum by the total amount of the customer's spending in the payment network during the time period.

Block 1114 represents a data analysis tool that may be referred to as a “merchant loyalty score range” or “loyalty to merchant indicator” analysis tool. The output of this tool may be, for each customer, a code or indicator that indicates a category or classification (such as high, medium or low) that characterizes the particular customer's degree of loyalty to the merchant/client. The degree of loyalty may be determined in a number of ways, such as by a combination of the merchant/client's share of visits and share of spend (wallet) from the customer relative to the merchant/client's peers/competitors. Example techniques for calculating customers' degree of loyalty to a merchant are disclosed in U.S. published patent application no. 2011/0106607, which names Alfonso et al. as inventors and which is assigned to the assignee hereof.

Block 1116 represents a data analysis tool that may be referred to as a “spend with industry” tool. The output of this tool may be, for each customer, a code or indicator that indicates a category or classification (such as high, medium or low) that characterizes the total amount spent by the particular customer during a pre-determined period of time for a category of purchases, where the category of purchases is all purchases made by the customer at or from the type of store that includes the merchant/client. For example, the total of such purchases for the customer may be calculated and two thresholds may be applied to classify the customer as a high, medium or low spender in the category of purchases. For example, if the customer's total spend in the category is more than the higher one of the two thresholds, the customer is classified as a high spender; if the customer's total spend in the category is less than the lower one of the two thresholds, the customer is classified as a low spender; otherwise the customer is classified as a medium spender. Other variations on this tool may include classifying the customer as a high, medium or low spender with a type of store (such as a type of specialty store) that does not include the merchant/client.

Block 1118 represents a data analysis tool that may be referred to as a “spend with peer group” tool. The output of this tool may be, for each customer, a code or indicator that indicates a category or classification (such as high, medium or low) that characterizes the total amount spent by the particular customer during a pre-determined period of time with a group of merchants, where the group of merchants is defined as the merchant/client's peers, and the group may or may not include the merchant/client when the classification of the customer is determined. For example, the total of the customer's purchases with the group of merchants may be calculated and two thresholds may be applied to classify the customer as a high, medium or low spender with the peer group of merchants.

Block 1120 represents a data analysis tool that may be referred to as an “online share of wallet” tool. The output from this tool may represent the proportion of the spending done online by the customer in question with the merchant/client during a pre-defined time period relative to the customer's total spending online in a pre-defined group of merchants during that time period, where the group of merchants may consist of the merchant/client and a set of its competitors. This output, for each customer, may be expressed as a percentage obtained by adding up the customer's online transaction amounts with the merchant/client during the time period and dividing the resulting sum by the total amount of the customer's online transactions with the group of merchants during that time period.

Considering the share of wallet (block 1102) and the online share of wallet (block 1120) tools together, it should be noted that an alternative possible analysis tool would provide share of wallet for in-store purchases only, in contrast to the total share of wallet results provided by the first share of wallet tool, and the online only share of wallet results provided by the tool represented by block 1120.

Block 1122 represents a data analysis tool that may be referred to as an “online share of visits” tool. The output from this tool may represent the proportion of transactions by the customer in question made online with the merchant/client during a pre-defined time period relative to the total number of online transactions by the customer with a pre-defined group of merchants during the time period, where the group of merchants may consist of the merchant/client and a set of its competitors. This output, for each customer, may be expressed as a percentage obtained by adding up the number of the customer's online transactions with the merchant/client during the time period and dividing the resulting sum or total by the customer's total number of online transactions with the group of merchants during that time period.

Block 1124 represents a data analysis tool that may be referred to as an “online channel preference” tool. The output from this tool may represent a proportion of a customer's spending in online transactions for a category of purchases relative to the customer's total spending in the category of purchases. This output, for each customer, may be expressed as a percentage obtained by totaling the amounts of the customer's online purchases in the relevant category and dividing the resulting sum by the sum of the amounts of all of the customer's purchases (online plus in-store) in that category.

In some embodiments, the transaction analysis computer 900 may distinguish between customers' online and in-store transactions based on data included in the payment network transaction data obtained from network transaction data store 802 (FIG. 8).

Block 1126 in FIG. 11 represents a data analysis tool that may be referred to as a “favorite segments by spend” tool. The output from this tool may be a set of codes that identify one or more (for example three) retail segments or industries in which the customer spends the most money. This output may be produced by analyzing the customer's spending by segment to identify the customer's favorite segments by total dollar amount of purchases in each segment.

Block 1128 represents a data analysis tool that may be referred to as a “favorite segments by visits” tool. The output from this tool may be a set of codes that identify one or more (for example three) retail segments or industries in which the customer engages in the most transactions. This output may be produced by analyzing the customer's transactions by segment to identify the customer's favorite segments by total number of transactions in each segment.

It should be noted that a large part, and possibly all, of the output data produced by the above-described data analysis tools may be considered to be shopping habits data in that it is derived from and/or indicates directly or indirectly shopping habits of the customer in question. Perhaps the analysis tool output data that most directly reflects the customers' shopping habits are those from the data analysis tools represented by blocks 1102, 1104, 1106, 1108, 1110, 1112, 1120, 1122, 1126 and 1128 of FIG. 11, all as described above.

Moreover, at least some of the output data from the analysis tools can be referred to as classification data, in the sense that the output data indicates a classification or group to which the analysis by the tool has assigned the customer in question. Particular examples of such data are the outputs from the tools represented in FIG. 11 by blocks 1114, 1116, 1118 and 1124.

Still further, it may also be said that output data from some or perhaps all of the analysis tools can be called attribute data, i.e., data that indicates one or more attributes of the merchant/client's customers. For example, the return transaction data output from the tool represented by block 1106 may be considered to indicate the customers' behavior with respect to return transactions, and such behavior may be deemed an attribute of the customers. Similarly, a customer's degree of loyalty to the merchant/client, as indicated by the output from the merchant loyalty score range tool (block 1114), may be considered an attribute of the customer in question. Moreover, all or almost all of the shopping habits data, including for example average transaction size (see discussion of block 1108 above), may be considered to indicate attributes of the customers.

In referring to shopping habits data, classification data and attribute data, it is not intended to imply that these types of data are in any way mutually exclusive. Rather it may often be the case that all three characterizations could be applied to the output data from a given one of the analysis tools described above. The type of data referred to as attribute data is broad enough to encompass all of the analysis tool outputs described above. Moreover, a tool that, as described herein, does not necessarily produce classification data could nevertheless readily be modified to do so. For example, any tool that outputs a score or percentage could readily also or alternatively output a customer classification by applying one or more thresholds to the score or percentage.

While a considerable number of analysis tools and variations thereof have been described above, it is contemplated that other or additional tools could be defined and deployed in some embodiments. It is also contemplated that some or all of the data analysis tools represented in FIG. 11 may be omitted in some embodiments and/or may be replaced by one or more other data analysis tools.

In embodiments of the present invention, payment network transaction data is linked to a merchant's customer transaction data by inferred matching using operations on only de-identified data sets. The linkage occurs in a manner that protects customer privacy while permitting valuable information to be gleaned from the linked payment network transaction data. In generating this information, one or more data analysis tools may be employed to produce output data indicative of customer shopping habits, classification or other attributes. The resulting output data (customer-level information) from the data analysis tool(s) may be appended to the merchant transaction data set, and the customer-level information may be returned to the merchant/client to support and enhance the merchant's marketing, advertising and/or promotional efforts.

As used herein and in the appended claims, the term “anonymized transaction data” includes transaction data from which identifying information has been removed, as well as transaction data that for any other reason lacks identifying information.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving a first data set, the first data set including anonymized transaction data representing purchase transactions made by customers of a merchant;
receiving a second data set, the second data set including anonymized transaction data representing purchase transactions made by cardholders in a payment network;
filtering the second data set to remove therefrom data relating to cardholders who are not customers of the merchant;
processing said first data set and said filtered second data set using a probabilistic engine to establish linkages between data in the first data set and data in the filtered second data set;
analyzing data in the filtered second data set for which linkages exist with data in the first data set to generate shopping habits data for customers of the merchant; and
appending the shopping habits data to the first data set.

2. The method of claim 1, wherein the shopping habits data includes data that indicates a proportion of a customer's spending with the merchant relative to the customer's total spending in a group of merchants that includes the merchant.

3. The method of claim 1, wherein the shopping habits data includes data that indicates a proportion of a customer's transactions with the merchant relative to a total number of transactions by the customer in a group of merchants that includes the merchant.

4. The method of claim 1, wherein the shopping habits data is indicative of a proportion of return transactions engaged in by a customer relative to the customer's total purchase transactions.

5. The method of claim 1, wherein the shopping habits data is indicative of an average dollar amount of transactions engaged in by the customers in a group of merchants.

6. The method of claim 1, wherein the shopping habits data is indicative of a frequency of transactions engaged in by the customers in a group of merchants.

7. The method of claim 1, wherein the shopping habits data includes data that indicates a proportion of a customer's spending with the merchant relative to the customer's overall spending in the payment network.

8. The method of claim 1, wherein the shopping habits data includes data that indicates a proportion of a customer's spending in online transactions with the merchant relative to the customer's overall spending in online transactions in a group of merchants that includes the merchant.

9. The method of claim 1, wherein the shopping habits data includes data that indicates a proportion of a customer's online transactions with the merchant relative to the customer's overall number of online transactions in a group of merchants that includes the merchant.

10. The method of claim 1, wherein the shopping habits data includes data that indicates a proportion of a customer's spending in online transactions for a category of purchases relative to the customer's total spending in the category of purchases.

11. The method of claim 1, wherein the shopping habits data includes data indicative of a customer's favorite retail segments as indicated by quantity of spending and/or quantity of transactions.

12. A method comprising:
receiving a first data set, the first data set including anonymized transaction data representing purchase transactions made by customers of a merchant;
receiving a second data set, the second data set including anonymized transaction data representing purchase transactions made by cardholders in a payment network;
filtering the second data set to remove therefrom data relating to cardholders who are not customers of the merchant;
processing said first data set and said filtered second data set using a probabilistic engine to establish linkages between data in the first data set and data in the filtered second data set;
analyzing data in the filtered second data set for which linkages exist with data in the first data set to generate classification data for classifying the merchant's customers into groups of customers; and
appending the classification data to the first data set.

13. The method of claim 12, wherein the classification data is indicative of the customers' loyalty to the merchant.

14. The method of claim 12, wherein the classification data is indicative of the customers' respective total amounts spent for a category of purchases.

15. The method of claim 12, wherein the classification data is indicative of the customers' respective total amounts spent with a group of merchants.

16. A method comprising:
receiving a first data set, the first data set including anonymized transaction data representing purchase transactions made by customers of a merchant;
receiving a second data set, the second data set including anonymized transaction data representing purchase transactions made by cardholders in a payment network;
filtering the second data set to remove therefrom data relating to cardholders who are not customers of the merchant;
processing said first data set and said filtered second data set using a probabilistic engine to establish linkages between data in the first data set and data in the filtered second data set;
analyzing data in the filtered second data set for which linkages exist with data in the first data set to generate attribute data for indicating at least one attribute of customers of the merchant; and
appending the attribute data to the first data set.

17. The method of claim 16, wherein the attribute data is indicative of a customer's behavior with respect to return transactions.

18. The method of claim 16, wherein the attribute data is indicative of a customer's degree of loyalty to the merchant.

19. The method of claim 16, wherein the attribute data is indicative of at least one shopping habit of a customer.

20. The method of claim 19, wherein the attribute data is indicative of a customer's average transaction amount in a category of transactions.
